(19) United States
(12) Patent Application Publication
(10) Pub. No.: US 2020/0309294 A1
(43) Pub. Date: Oct. 1, 2020

(54) GROOVED CLAMP FOR AUTOMOTIVE VEHICLE EXHAUST DIFFUSERS

(71) Applicant: Marcos Graça JARDIM, Maringa (BR)

(72) Inventor: Marcos Graça JARDIM, Maringa (BR)

(21) Appl. No.: 16/420,432

(22) Filed: May 23, 2019

(30) Foreign Application Priority Data
Mar. 29, 2019 (BR) 20 2019 006335-7

(51) Int. Cl. F16L 23/08; F01N 13/18

(52) U.S. Cl. CPC F16L 23/08; F01N 13/1805

(57) ABSTRACT

A grooved clamp for automotive vehicle exhaust diffusers which, in accordance with the characteristics thereof, provides a grooved clamp in a specific, stand-alone structure of the mechanical type and based on a longitudinal side groove, a rear cross-sectional groove and two attaching tips, in order to provide, in an extremely practical, safe and accurate manner complete optimization procedures to press fit outlet nozzles and side connectors to the end sections of diffusers in automotive vehicle exhaust systems in general, coupled with increased operational ergonomics, aesthetics and fastening capacity.

### FIELD OF THE INVENTION

The present invention relates to vehicle accessories in general, and more particularly, to a grooved clamp for automotive vehicle exhaust diffusers which, according to the general characteristics thereof, provides, as its basic principle, a grooved clamp in a specific, stand-alone structure of mechanical type and based on a longitudinal side groove, a rear cross-sectional groove and two attaching tips, in order to provide, in an extremely practical, safe and accurate manner, complete optimization procedures to press fit outlet nozzles and side connectors to the end sections of sports vehicles exhaust diffusers in general, and being based on increased operational ergonomics, aesthetics and fastening capacity.

### DISCUSSION OF THE PRIOR ART

With a specific design and format and easy access for better adaptation and user safety, convenience features in handling and functionality, very affordable and, due to its general characteristics and dimensions, easily adaptable to a variety of diffusers, exhaust systems, automotive vehicles, places and users in general, regardless of the characteristics that they may present.

Diffusers are automotive electronic devices, more specifically, accessories for automotive vehicles in general such as cars, directly installed in the automotive vehicle exhaust system so as to divert airflow and ensure change or modification in the sound made by automotive vehicles, thus producing a distinctive sports roaring sound when the engine is running. Diffusers allow the user to switch between original sound and sports sound when so desired by means of a power switch.

More specifically, a diffuser is usually located on the bottom rear of the vehicle and its aerodynamic purpose is to increase airflow speed underneath the vehicle, that is, air pressure underneath the vehicle is affected by the diffuser as the vehicle moves.

When installed in automotive vehicles, diffusers allow burning of not-expelled exhaust gas, prevent normal exhaust gas flow, reduce hydrocarbon exhaust emissions, reuse gasoline without the danger of lead poisoning and reduce carbon monoxide emissions.

As a fully exposed part at vehicle exhaust systems, diffusers must be highly functional and efficient to divert airflow and ensure better sound quality, besides being provided with a pleasant design and excellent finish details.

However, despite being widely used for a long time in the most diverse types of exhaust systems from a wide range of automotive vehicles, well-known diffusers in the current state of the art present several drawbacks in their use such as high complexity in the installation/uninstallation procedures and routine maintenance, especially in the attachment of other parts from the exhaust system such as outlet nozzles and side connectors.

Therefore, a diffuser that allows the attachment of outlet nozzles and side connectors directly to its body by means of pairs of tongue and groove flanges has been designed, more particularly, a diffuser provided with a groove flange welded to the side connector fastening side and a tongue flange welded to the outlet nozzle fastening side, just as the side connector is provided with a tongue flange and the outlet nozzle is provided with a groove flange. These pairs of tongue-groove flanges are fastened to each other necessarily by specific moving clamps.

In this line of action, the structuring of a practical, safe, accurate and ergonomic clamp which is largely able to adapt and fasten outlet nozzles and side connectors to the end sections of diffusers in automotive vehicle exhaust systems in general has become indispensable for both manufacturers and users of these types of vehicle diffusers.

In an extensive review of the literature aiming to establish the current state of the art on clamps in general, mainly grooved clamps for automotive vehicles, no relevant prior art documents disclosing the specific object claimed in the present invention were found, namely, no document disclosing a clamp with a set of inner grooves and attaching tips adjusting around the tongue and groove flanges of automotive vehicle diffusers.

### SUMAMRY OF THE INVENTION

The present invention is characterized by combining components and procedures in a differentiated design that meets the various requirements the nature of its use demands, i.e., to attach outlet nozzles and side connectors to vehicle diffusers. That concept ensures a grooved clamp of great efficiency, functionality, strength, durability, safety, versatility, accuracy, economy, and ergonomics due to the excellent aggregate technical qualities, which provide advantages and improvements in the press fitting and fastening of diffusers to vehicle exhaust systems in general and whose general characteristics differ from the other shapes and models widely known in the current state of the art.

Thus, the overall design of the present grooved clamp for automotive vehicle exhaust diffusers, object of the present invention, is entirely based on a simple and robust structure with a required minimum number of components and extremely simplified, safe and optimized applicability, combined with fairly practical manufacturing and maintenance procedures so as to produce a practical and efficient grooved clamp able to fasten via its grooves and attaching tips, with high accuracy, safety and ergonomics, outlet nozzles and side connector to the end sections of diffusers in automotive vehicle exhaust systems in general, as well as to enable routine handling procedures—maintenance and replacement.

The present invention comprises the use of a modern, efficient, safe and functional grooved clamp for automotive vehicle exhaust diffusers formed by a set of properly incorporated mechanical and vehicle solutions, forming a complete and differentiated grooved clamp with a unique design, great finish details and specific characteristics, which incorporates its own specific stand-alone structure of the manual type, of high durability and strength, open annular shape and containing a properly integrated and symmetrically arranged longitudinal side groove as an attachment element on the flange outer edges, a rear cross-sectional groove as a joining element for the clamp, two attaching tips as attaching elements for the clamp and a fastening bolt and nut as a fastening element for the clamp, in order to make it possible to form a single, complete and safe assembly, whose shapes and internal and external arrangements enable seamless adaptation to several different types of vehicle diffusers in general, and specially designed for these purposes with proper geometry.

The present grooved clamp is based on the application of components and processes in a differentiated concept without, however, achieving a high degree of sophistication and complexity, thus making it possible to solve some of the main drawbacks of other shapes and models known in the state of the art and employed in procedures to fasten outlet nozzles and side connectors to automotive vehicle diffusers, which are located in an operating range in which are very common the limitations on use and application, low efficiency and performance, accidents of different severities, high insecurity, great wear and fragility, low durability and strength, low versatility, high losses, no ergonomics, low performance, high inaccuracy, high cost, general high volume and weight, laborious applications, high maintenance, great waste of time and complex manufacturing process.

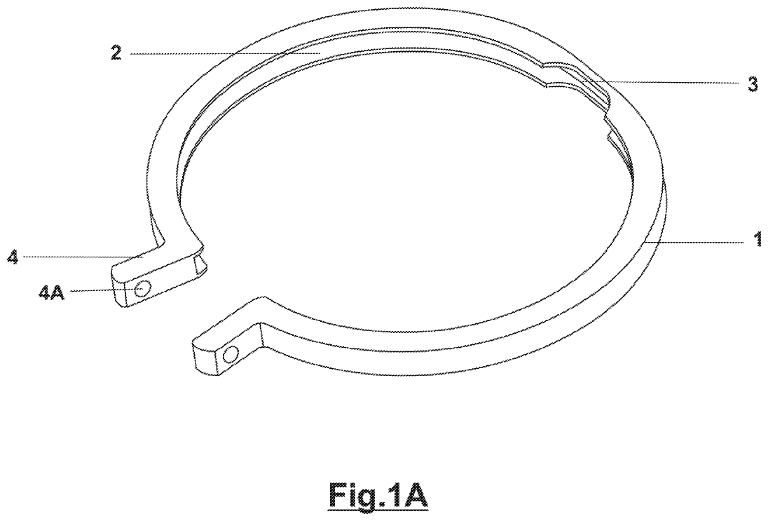

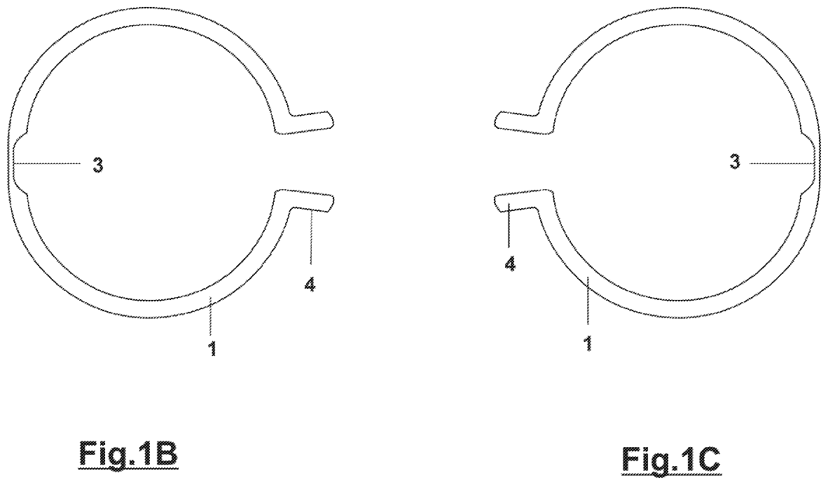

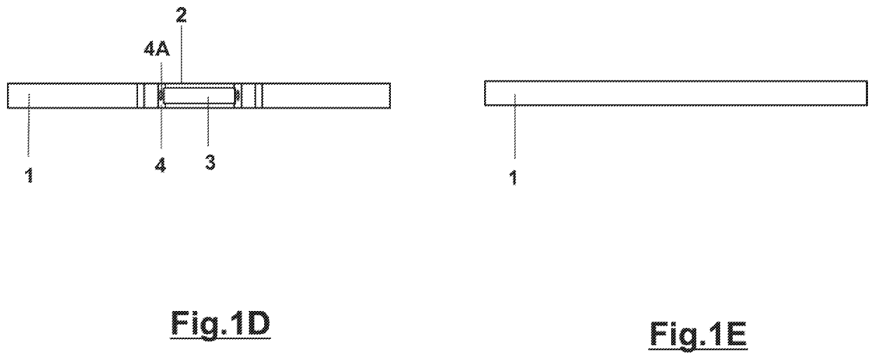

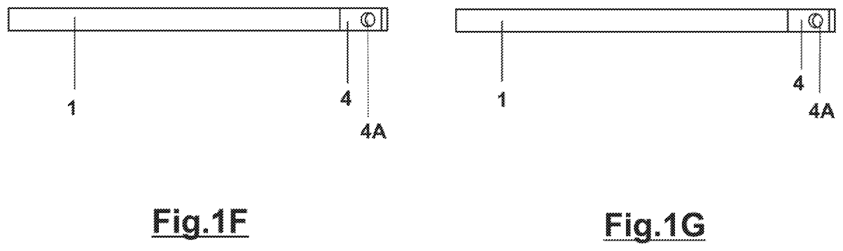

FIG. 1A is a perspective view of the grooved clamp for automotive vehicle exhaust diffusers.

FIG. 1B is a top plan view of the grooved clamp for automotive vehicle exhaust diffusers.

FIG. 1C is a bottom plan view of the grooved clamp for automotive vehicle exhaust diffusers.

FIG. 1D is a front view of the grooved clamp for automotive vehicle exhaust diffusers.

FIG. 1E is a rear view of the grooved clamp for automotive vehicle exhaust diffusers.

FIG. 1F is a right side view of the grooved clamp for automotive vehicle exhaust diffusers.

FIG. 1G is a left side view of the automotive vehicle exhaust diffusers.

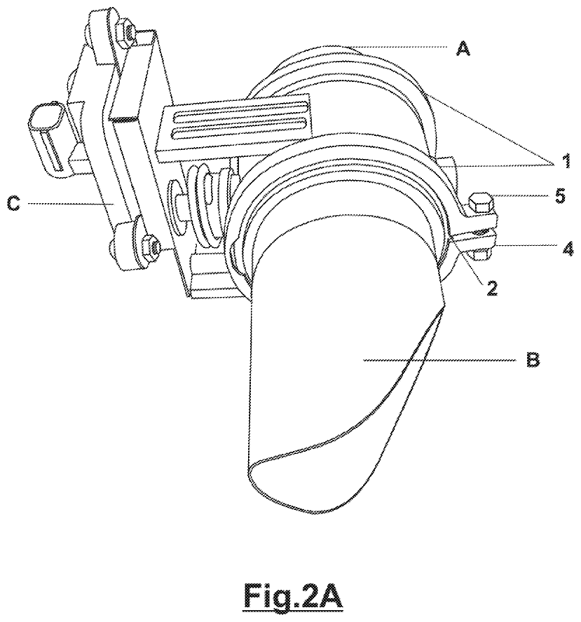

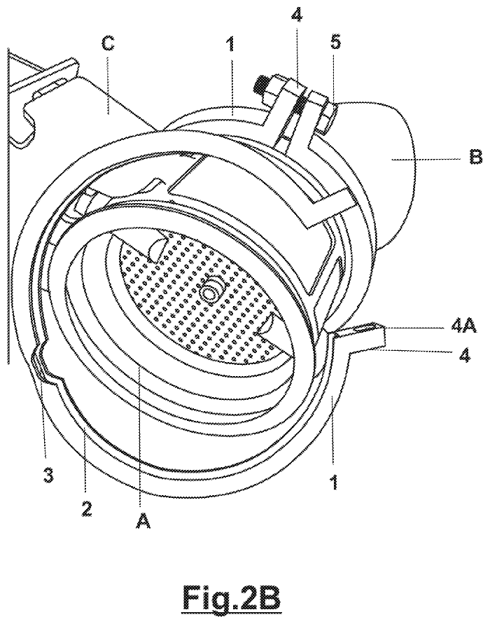

FIG. 2A is a perspective view of the grooved clamp for automotive vehicle exhaust diffusers applied to an automotive diffuser.

FIG. 2B is a top plan view of the grooved clamp for automotive vehicle exhaust diffusers applied to an automotive diffuser.

As it can be inferred from the attached figures illustrating and integrating the present descriptive report of the invention “Grooved Clamp for Automotive Vehicle Exhaust Diffusers”, the grooved clamp is shown in FIG. 1A) in a general manner, as consisting of a grooved clamp (1) complete and having unique characteristics, optimum finish details, which incorporates a specific and stand-alone structure of the manual type of high durability and resistance, having a general open annular shape, internal and external shapes and arrangements adaptable to the outlet nozzles (A) and side connectors (B) of automotive vehicle exhaust diffusers (C), and which contains, perfectly integrated and symmetrically arranged between them, a longitudinal side groove (2) of general annular shape with a semi-elliptical cross-section, horizontally, perpendicularly and symmetrically arranged around the entire length of the grooved clamp (1) inner surface; a rear cross-sectional groove (3) of semi-elliptical shape, vertically, perpendicularly and symmetrically centered on the grooved clamp (1) rear-inner surface; two attaching tips (4) of parallelepipedal shape, each of them horizontally, perpendicularly and symmetrically arranged on a free end of the grooved clamp (1) opening and having a center opening (4A) of cylindrical shape, horizontally and symmetrically centered and transversely arranged on one attaching tip (4); and a fastening bolt with nut (5) horizontally and symmetrically arranged and transversely arranged consecutively to the two center openings (4).

The application of said grooved clamp for automotive vehicle exhaust diffusers is based on the perfect fitting on and around the entire length of the diffuser (C) tongue and groove flanges and the outlet nozzle (A) and the side connector (B). The diffuser (C) allows the outlet nozzles and the side connectors to be directly attached to its body by means of pairs of tongue and groove flanges, that is, the diffuser (C) is provided with a groove flange welded to the side connector (B) fastening side and a tongue flange welded to the outlet nozzle (A) fastening side, just as the side connector (B) is provided with a tongue flange and the outlet nozzle (A) is provided with a groove flange.

Thus, the grooved clamps (1) are symmetrically arranged on and around the entire length of the outer edges of the tongue and groove flanges between the outlet nozzle (A) and the diffuser (C) and between the side connector (B) and the diffuser (C). Once fitted, the clamps are fastened and pressed on and around the tongue and groove flanges by the fastening bolt and nut (5).

Since the components of the grooved clamp for automotive vehicle exhaust diffusers are fully integrated between them, nothing unfastens and breaks or tears, attaining a high level of performance and efficiency, combined with high durability and absolute safety. Once the components are fully integrated between them, they are maintained fitted and cohesive to prevent detachment when in use, the set being fully available for the fastening procedures between the tongue and groove flanges of the outlet nozzle (A) and the side connector (B) to the diffuser (C). Therefore, the grooved clamp (1) can be used without concerns of any nature, especially regarding the durability and safety of its components, as well as the users' safety.

Considering the foregoing, the present vehicle accessory will be well received by sports car exhaust system users in general, since the grooved clamp for automotive vehicle exhaust diffusers has several advantages, such as: great safety, reliability and ease of application; great efficiency and performance in its application due to its general conception; high comfort, convenience and safety to users; extremely high general resistance and durability, coupled with a low or absent wear of the set as a whole; completely affordable costs which provides excellent cost-benefit ratio; practical and safe use by any user; wide reach range; extremely low and practical general maintenance; perfect and direct adaptation to automotive diffusers (C); high operational accuracy; fully compatible weight and general dimensions; high ergonomics; excellent structural capacity; excellent capacity of coordinating and regulating components; and the certainty of having a grooved clamp (1) which fully meets the law and regulations in force and the basic conditions necessary to its application.

Due to its features the grooved clamp for automotive vehicle exhaust diffusers is totally versatile, efficient, practical and safe to be applied to the procedures of manually attaching the outlet nozzles (A) and the side connectors (B) to the diffusers (C) of the most diverse types of automotive vehicles and the most diverse types of users, regardless of the general characteristics these may present; it is also characterized by a great ease of application and handling, combined with great performance and excellent general characteristics; however, the measures, sizes and quantities may vary according to the needs.

1. A grooved clamp for automotive vehicle exhaust diffusers, comprising a grooved clamp (1) incorporating a stand-alone structure of open annular shape and containing integrated and symmetrically arranged between them a longitudinal side groove (2) of annular shape with a semi-elliptical cross-section horizontally, perpendicularly and symmetrically arranged around the entire length of the grooved clamp (1) inner surface; a rear cross-sectional groove (3) of semi-elliptical shape vertically, perpendicularly and symmetrically centered on the grooved clamp (1) rear-inner surface; two attaching tips (4) of parallelepipedal shape and each of them horizontally, perpendicularly and symmetrically arranged on a free end of the grooved clamp (1) opening and having a center opening (4A) of cylindrical shape horizontally and symmetrically centered and transversely arranged on an attaching tip (4); and a fastening bolt with nut (5) horizontally and symmetrically transversely arranged consecutively to the two center openings (4).
